(19) United States
(12) Patent Application Publication
(10) Pub. No.: US 2012/0032869 A1
(43) Pub. Date: Feb. 9, 2012

(54) FREQUENCY SCALABLE LOW PROFILE BROADBAND QUAD-FED PATCH ELEMENT AND ARRAY

(76) Inventor: Terrance J. Hawkins, Sunnyvale, CA (US)

(21) Appl. No.: 12/852,956

(22) Filed: Aug. 9, 2010

(51) Int. Cl. H01Q 1/50

(52) U.S. Cl. 343/857

(57) ABSTRACT

A quad-fed patch antenna is disclosed, including a ground plane and a substantially tetragonal radiating patch spaced from the ground plane, an upper surface of the substantially tetragonal radiating patch having a first side, a second side, a third side, and a fourth side defining a first corner, a second corner, a third corner, and a fourth corner located within a second plane substantially parallel to the ground plane. A signal feed is associated with the each side of the substantially tetragonal radiating patch, wherein the first signal feed, the second signal feed, the third signal feed and the fourth signal feed are fed progressively in phase quadrature.

### STATEMENT REGARDING FEDERALLY SPONSORED RESEARCH OR DEVELOPMENT

Not applicable.

### FIELD OF THE INVENTION

The present disclosure relates to a patch antenna, and more particularly, to a patch antenna for transmitting and receiving circularly polarized radio signals for use in a broadband mobile communication system.

### BACKGROUND OF THE INVENTION

In wireless communication systems, a radiofrequency signal is created or received by generating or receiving an electromagnetic field in an antenna. Depending upon the requirements of the communication system, the antenna may be formed in one of a plurality of configurations.

In communications systems utilizing satellites, the polarization of the antenna is a significant consideration. Linear polarization requires that a receiving station tightly align its frame of reference with that of a satellite in order to achieve acceptable communications. In particular, signal reception may be affected by relative movement of the transmitting station (i.e. the satellite) with respect to the receiving station, or by differences in orientation between the transmitting and receiving station antennas. Additionally, as linearly polarized signals propagate through the atmosphere, the signals tend to rotate, changing the signal orientation and making it difficult to maintain alignment between the transmitter and the receiver. As a result, satellite communications usually require antennas that transmit and receive circularly polarized signals. Circular polarization of the signals minimizes the geometric and atmospheric effects. However, to achieve satisfactory communication, the degree of circular polarization as measured by axial ratio should be relatively high over a relatively broad bandwidth.

Patch antennas are relatively inexpensive to manufacture, and have certain desirable characteristics (such as ease of manufacture, simplicity, small size, and low weight) but patch antennas are inherently linearly polarized, which results in at least a 3 dB gain loss for circularly polarized signals. Nevertheless, patch antennas that transmit and/or receive circularly polarized signals, as opposed to linearly polarized signals, are particularly useful in satellite communication systems due to their desirable characteristics.

Several methods are known to obtain circular polarization from a square or rectangular patch antenna. In one method, a single feed is placed at the corner of an approximately square patch. In a second method, a corner truncated square patch is provided with a single feed located at the edge midpoint. In a third method, a slotted square patch with a small slot located at its center along the diagonal may be provided with a single feed along the edge midpoint. These single feed methods are relatively simple and may be moved inboard to change the input impedance seen by the patch.

It is also known to provide two feeds to create circular polarization by placing the feeds at the midpoints of adjacent edges, or at adjacent corners of the patch edge, thereby separating the feeds physically by 90 degrees. It is also known to provide signals to the electronic feeds located on adjacent edges or corners that are 90 degrees out of phase with respect to each other, known generally as phase quadrature, to obtain narrow-band circularly polarized signals. However, the circular polarization quality, as measured by axial ratio, degrades over a large bandwidth.

In certain frequency band having a wideband frequency range, such as for certain global positioning arrangements, for communications on the move, or for certain military uses, it is desirable that an antenna be able to transmit and receive high quality circularly polarized signals having a relatively large bandwidth (i.e. broadband) and having a relatively large beamwidth. As a non-limiting example, certain communication systems that enable communications on the move may implement various code division multiple access (CDMA) protocols over a given frequency band to provide mobile users with voice, data, and video communication beyond line of sight and while in motion. The frequency band utilized may range from higher frequency GHz bands to lower frequency UHF bands to provide communications to users in environments, such as heavily-forested areas, where higher frequency signals are heavily attenuated. Communications on the move also require a high quality circularly polarized signal having an axial ratio below about 2.0 dB over a relatively large bandwidth, on the order of 150 MHz or more.

It is therefore desirable to provide a patch antenna having a low axial ratio over an extended bandwidth (broadband) that is easy and inexpensive to fabricate, and is relatively small and lightweight.

### SUMMARY OF THE INVENTION

Compatible and attuned with the present invention, a patch antenna having a low axial ratio over an extended bandwidth that is easy and inexpensive to fabricate, and is relatively small and lightweight has been surprisingly discovered.

A quad-fed patch antenna comprises a ground plane having an upper surface substantially within a first plane, and a substantially tetragonal radiating patch spaced from the ground plane. An upper surface of the substantially tetragonal radiating patch includes a first side, a second side, a third side, and a fourth side defining a first corner, a second corner, a third corner, and a fourth corner located within a second plane substantially parallel to the first plane. A first signal feed is associated with the first side of the substantially tetragonal radiating patch. A second signal feed is associated with the second side of the substantially tetragonal radiating patch. A third signal feed is associated with the third side of the substantially tetragonal radiating patch. And a fourth signal feed is associated with the fourth side of the substantially tetragonal radiating patch. The first signal feed, the second signal feed, the third signal feed and the fourth signal feed are fed progressively in phase quadrature.

In one embodiment, the substantially tetragonal radiating patch is substantially square. In another embodiment, the first signal feed is attached to the first corner, the second signal feed is attached to the second corner, the third signal feed is attached at the third corner, and the fourth signal feed is attached at the fourth corner. The signal feeds may be arranged to transceive clockwise circularly polarized signals, or the signal feeds may be arranged to transceive counter-clockwise circularly polarized signals.

A plurality of the substantially coplanar tetragonal radiating patches may be arranged in a square tiled configuration to produce an array antenna wherein four of the substantially coplanar tetragonal radiating patches are located proximate each vertex. The first signal feeds are received substantially simultaneously by the plurality of substantially coplanar tetragonal radiating patches, the second signal feeds are received substantially simultaneously by the plurality of substantially coplanar tetragonal radiating patches, the third signal feeds are received substantially simultaneously by the plurality of substantially coplanar tetragonal radiating patches, and the fourth signal feeds are received substantially simultaneously by the plurality of substantially coplanar tetragonal radiating patches. Additionally, the first signal feeds, the second signal feeds, the third signal feeds, and the fourth signal feeds are fed progressively in phase quadrature. The first corners of each substantially coplanar tetragonal radiating patch, the second corners of each substantially coplanar tetragonal radiating patch, the third corners of each substantially coplanar tetragonal radiating patch, and the fourth corners of each substantially coplanar tetragonal radiating patch are geometrically oriented to be in the same location on each of the plurality of substantially coplanar tetragonal radiating patches.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is schematic top perspective view of a single patch antenna according to the present disclosure;

FIG. 2A is a graph of axial ratio versus frequency for an exemplary square patch antenna having a single feed at a first corner according to the prior art;

FIG. 2B is a graph of axial ratio versus frequency for an exemplary square patch antenna having a dual feed at a first and a second corner according to the prior art;

FIG. 2C is a graph of axial ratio versus frequency for an exemplary square patch antenna having a dual feed at a first and a third corner;

FIG. 2D is a graph of axial ratio versus frequency for an exemplary square patch antenna having a quad feed at a first corner, a second corner, a third corner, and a fourth corner, constructed and operated according to the present disclosure;

FIG. 3 is a schematic top perspective view of an antenna array including a plurality of patch antennas according to the present disclosure; and

FIG. 4 is an enlarged schematic top perspective view of the antenna array of FIG. 3 taken within circle 4 showing a slot intersection between four adjacent patches according to the present disclosure.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner.

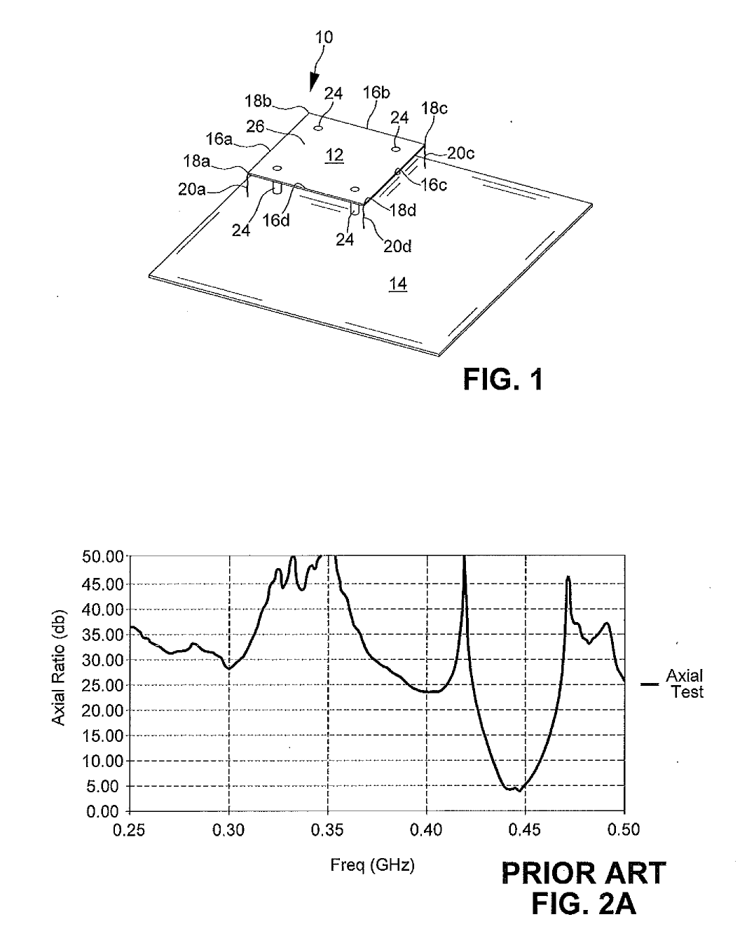

FIG. 1 shows a quad-fed patch antenna 10 according to one embodiment of the present disclosure. A generally tetragonal patch 12 is substantially parallel to and spaced from a ground plane 14 that lies within a first plane. It is understood that the patch 12 may have other four-sided shapes, but a substantially square patch 12 will maximize the performance of the patch antenna 10. The patch 12 includes a first side 16a, a second side 16b, a third side 16c, and a fourth side 16d. The sides 16a, 16b, 16c, 16d cooperate to define a first corner 18a, a second corner 18b, a third corner 18c, and a fourth corner 18d. The patch 12 is substantially flat so that an upper surface 26 of the patch 12, including the corners 18a, 18b, 18c, 18d, lies substantially within a second plane. The patch 12 may have any dimensions capable of broadcasting in any frequency range, and may further be formed as a radiating layer on top of a dielectric layer (not shown). The space between the patch 12 and the ground plane 14 may further be filled partially or completely with a dielectric material (including air), as is known in the art. Spacers 24 may be used to affix the patch 12 to the ground plane 14 while maintaining a desired separation therebetween.

In one embodiment, the patch 12 includes four progressively fed signal feeds 20a, 20b (not shown), 20c, 20d associated with the respective sides 16a, 16b, 16c, 16d, resulting in a quad-fed arrangement. The progressively fed signal feeds 20a, 20b, 20c, 20d may be attached to the midpoints of the respective sides 16a, 16b, 16c, 16d to locate each of the progressively fed signal feeds 20a, 20b, 20c, 20d physically 90° out of phase with the preceding signal feed. However, it is often easier to achieve 90° of physical separation between adjacent signal feeds 20a, 20b, 20c, 20d by attaching the signal feeds at the corners of the patch. Thus, in another embodiment and as shown in FIG. 1, the four progressively fed signal feeds 20a, 20b, 20c, 20d are attached to the respective corners 18a, 18b, 18c, 18d, resulting in a quad-fed arrangement of the patch 12. Additionally, the progressively fed signal feeds 20a, 20b, 20c, 20d provide a signal in phase quadrature, which requires that once the signal fed to the first corner 18a is defined by the feed system, the signal fed to the second corner 18b lags the signal fed to the first corner 18a by 90°, the signal fed to the third corner 18c lags the signal fed to the second corner 18b by 90° and lags the signal fed to the first corner 18a by 180°, and the signal fed to the fourth corner 18d lags the signal fed to the third corner 18c by 90° and lags the signal fed to the second corner 18b by 180° and lags the signal fed to the first corner 18a by 270°. In FIG. 1, the phase lag of the feed signals is shown at each corner 18a, 18b, 18c, 18d with respect to the signal received at the first corner 18a of the patch 12, and the progressively fed signal feeds 20a, 20b, 20c, 20d are aligned to provide clockwise circular polarization to the signal. It is understood that the progressively fed signal feeds 20a, 20b, 20c, 20d may also be aligned to provide counter-clockwise circular polarization. It is further understood that the feed system providing the signals to each corner 18a, 18b, 18c, 18d may be any known feed system capable of providing the required phase delays, including waveguides, hybrid systems, L probes, proximity aperture coupling systems, microstrip feed systems, or the like.

The quad-fed patch antenna 10 of FIG. 1 provides unexpectedly robust circular polarization, as measured by axial ratio. Axial ratio is an important parameter used to measure the quality of the circular polarization. Pure circular would have an axial ratio of 0 dB (i.e. 1) where the orthogonally polarized waves have equal amplitude and 90° phase difference. When the orthogonal components are misaligned the circular polarization tends to an ellipse where the axial ratio is the ratio of the major to minor axis. Therefore, it is desirable to keep the axial ratio as close to 0 dB as possible. Axial ratio, typically measured in dB, measures the differences between the maximum and the minimum peaks of polarization as a circularly polarized wave rotates through 360°. If the axial ratio is near 0 dB, a very small difference between the maximum and the minimum peaks of polarization exists. If the axial ratio is exceeds about 2 dB, the polarization is often referred to as elliptical. As noted previously hereinabove, certain mobile communications systems require that the axial ratio remain below 2 dB over a relatively large bandwidth, on the order of 150 MHz or more.

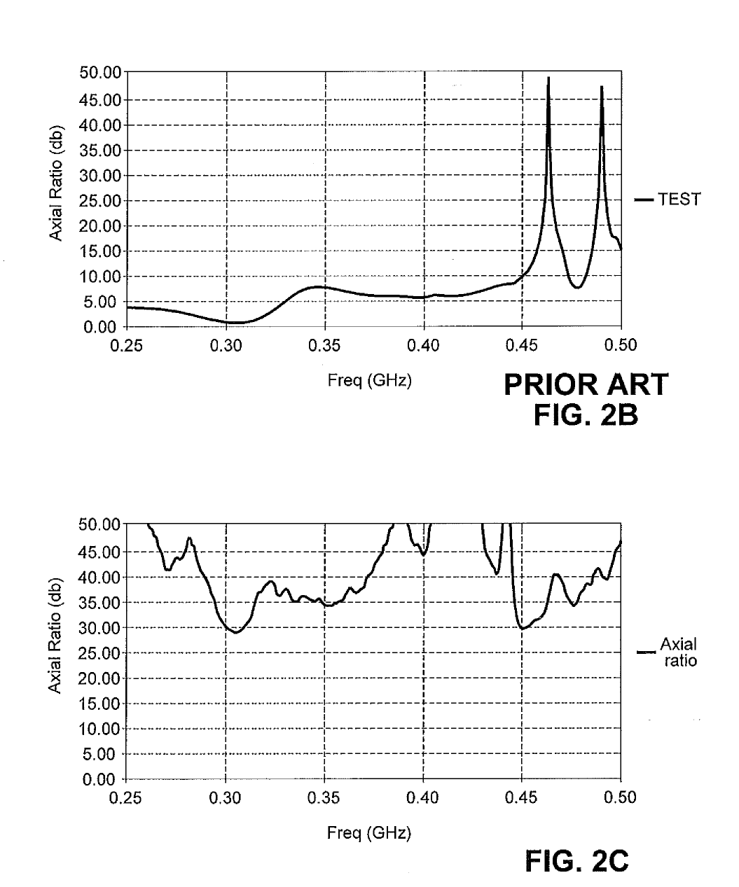

As a non-limiting example, a sample patch antenna representative of the patch antenna 10 of FIG. 1 was built and tested for use in the UHF band. The sample patch antenna 10 included a patch 12 formed of a substantially square copper foil approximately 40 cm (approximately 15.75 inches) in length, approximately 40 cm (approximately 15.75 inches) in width, and having a thickness of about 0.5 mm (about 0.020 inches), and formed on a dielectric substrate having a thickness of about 1.5875 mm (about 0.0625 inches). The patch 12 was spaced from the ground plane 14 by about 5 cm (about 2 inches). It is understood that the physical dimensions of the antenna may be varied or reduced to customize the antenna to any particular frequency range, including UHF, L-band, S-band, C-band, X-band, Ku-band, K-band, Ka-band, or the like. The axial ratio of the sample patch antenna 10 constructed as described was subjected to testing across a 250 MHz frequency band (from 250 to 500 MHz in the UHF band). FIG. 2A shows the axial ratio across the tested 250 MHz frequency band where the sample patch antenna 10 is fed only at the first corner 18a. When fed at a single corner 18a, the sample patch antenna 10 provides linear polarization only with high axial ratio values that are never less than about 5.0 dB.

FIG. 2B shows the axial ratio across the same 250 MHz frequency band where the sample patch antenna 10 is progressively fed at the first corner 18a and at the second corner 18b, where the dual feeds are offset by 90° in phase quadrature. The axial ratio was measured to be less than 2 dB only between about 288 MHz and 319 MHz, for a narrowband acceptable bandwidth of only 31 MHz, or about 12% of the tested bandwidth.

FIG. 2C shows the axial ratio across the measured 250 MHz frequency band where the sample patch antenna 10 is progressively fed at the first corner 18a and at the third corner 18c, where the dual feeds are phase offset by 180°. Similar to FIG. 2a, the sample patch antenna 10 provides linear polarization only, with extremely high axial ratio values that are never less than about 30 dB.

Finally, FIG. 2D shows the axial ratio across the measured 250 MHz frequency band where the sample patch antenna 10 is progressively fed according to the present disclosure at all four corners 18a, 18b, 18c, 18d in phase quadrature, where each feed is phase offset by 90° from the preceding corner as shown in FIG. 1. Unexpectedly, the sample quad-fed patch antenna 10 provides an acceptable axial ratio of less than about 2.0 dB across the entire 250 MHz frequency test band, resulting in a broadband capability. Even more unexpectedly, the quad-fed patch antenna 10 provides a broadband and extremely high quality circular polarization having an axial ratio less than about 1.0 dB between 250 MHz and 445 MHz.

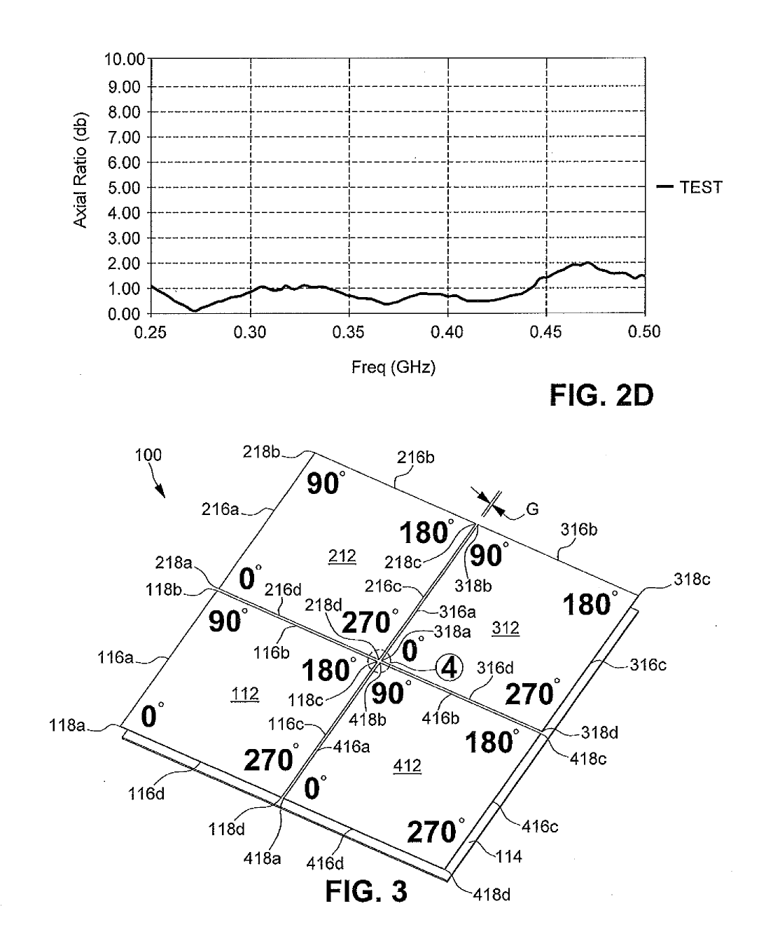

Advantageously and regardless of the targeted frequency band, the bandwidth of a single quad-fed patch antenna 10 of FIG. 1 may be further broadened by constructing an antenna array from a plurality of closely spaced quad-fed patch antennas. A representative antenna array 100 including four quad-fed patches 112, 212, 312, 412 arranged to develop clockwise circular polarization is shown in FIG. 3. It is understood that an antenna array 100 may have any number of quad-fed patches, and may be formed into any desired overall size and shape to achieve substantially any signal frequency, shape, and polarization, including counter-clockwise circular polarization. Favorable results have been obtained when the quad-fed patches are arranged in square tiling or a square grid, where four substantially square patches are arranged around every vertex.

In FIG. 3, the four substantially coplanar quad-fed patches 112, 212, 312, 412 are substantially equally spaced from a ground plane 114. The patches 112, 212, 312, 412 are arbitrarily numbered and will be described starting from the lower left and proceeding clockwise, but it is understood that the following description and features are not dependent upon the location of the patches 112, 212, 312, 412.

The first quad-fed patch 112 includes four sides 116a, 116b, 116c, 116d that define four corners 118a, 118b, 118c, 118d. The second quad-fed patch 212 includes four sides 216a, 216b, 216c, 216d that define four corners 218a, 218b, 218c, 218d. The third quad-fed patch 312 includes four sides 316a, 316b, 316c, 316d that define four corners 318a, 318b, 318c, 318d. And the fourth quad-fed patch includes four sides 416a, 416b, 416c, 416d that define four corners 418a, 418b, 418c, 418d.

For each of the patches 112, 212, 312, 412, the location of each of the respective first corners 118a, 218a, 318a, 418a and first sides 116a, 216a, 316a, 416a may be arbitrarily chosen. However, the patches 112, 212, 312, 412 are oriented so that the first sides 116a, 216a, 316a, 416a are substantially parallel. Similarly, the second sides 116b, 216b, 316b, 416b are substantially parallel, as are the third sides 116c, 216c, 316c, 416e and the fourth sides 116d, 216d, 316d, 416d. Additionally, the patches 112, 212, 312, 412 are geometrically oriented so that the first corners 118a, 218a, 318a, 418a are in the same location on each of the respective patches 112, 212, 312, 412. In FIG. 3, the first corners 118a, 218a, 318a, 418a are shown to be the lower left hand corner of each of the respective patches 112, 212, 312, 412. Subsequent corners of each of the patches 112, 212, 312, 412 are numbered in a clockwise direction because the antenna array 100 in FIG. 3 is arranged to transceive signals having primarily clockwise circular polarization, as described hereinbelow. It is understood that subsequent corners may be numbered in a counter-clockwise direction to obtain counter-clockwise circular polarization of transceived signals according to the description hereinbelow.

A progressive feed system (not shown) is attached to each of the corners of each of the patches 112, 212, 312, 412 so that each of the respective first corners 118a, 218a, 318a, 418a, second corners 118b, 218b, 318b, 418b, third corners 118c, 218c, 318e, 418c, and fourth corners 118d, 218d, 318d, 418d is progressively and substantially simultaneously fed 90° out of phase with the preceding corner. Thus, in one embodiment, each of the first corners 118a, 218a, 318a, 418a is fed simultaneously. Thereafter, each of the second corners 118b, 218b, 318b, 418b is simultaneously fed 90° out of phase with the first corners 118a, 218a, 318a, 418a. The third corners 118c, 218c, 318c, 418c are then progressively fed 180° out of phase with the first corners 118a, 218a, 318a, 418a, and are fed 90° out of phase with the second corners 118b, 218b, 318b, 418b. The fourth corners 118d, 218d, 318d, 418d are then progressively fed 270° out of phase with the first corners 118a, 218a, 318a, 418a, are fed 180° out of phase with the second corners 118b, 218b, 318b, 418b, and are fed 90° out of phase with the third corners 118c, 218c, 318c, 418c. The patch antenna array 100 of the present invention may have any shape or number of patch elements, as desired, and any number of the patch antennas may be actively fed, as desired. In one embodiment, in an antenna array 100 having a plurality of patches 112, 212, 312, 412, all of the patches 112, 212, 312, 412 receive the progressively fed signal feeds in phase quadrature. In another embodiment, the feed system may be controlled to feed less than all of the patches 112, 212, 312, 412, depending upon the desired signal shape and gain. As a non-limiting example, a first number of the patches may actively transceive signals, while a second number of the patches may be included as replacements for any active patch in the event that the active patch ceases operation for any reason.

As noted above, the patches 112, 212, 312, 412 are arranged as a square tiling substantially within in the same plane equally spaced from the ground plane 114. Each of the patches 112, 212, 312, 412 is spaced from adjacent patches by a predetermined gap G. Each of the patches 112, 212, 312, 412 is therefore electrically isolated from the adjacent patches. The gap G is typically on the order of one to two percent of a wavelength so that the array 100 resembles a slot antenna configuration having a vertex or slot intersection 500, which further increases the bandwidth of the antenna array 100. However, it is understood that other gap distances G may be used as desired.

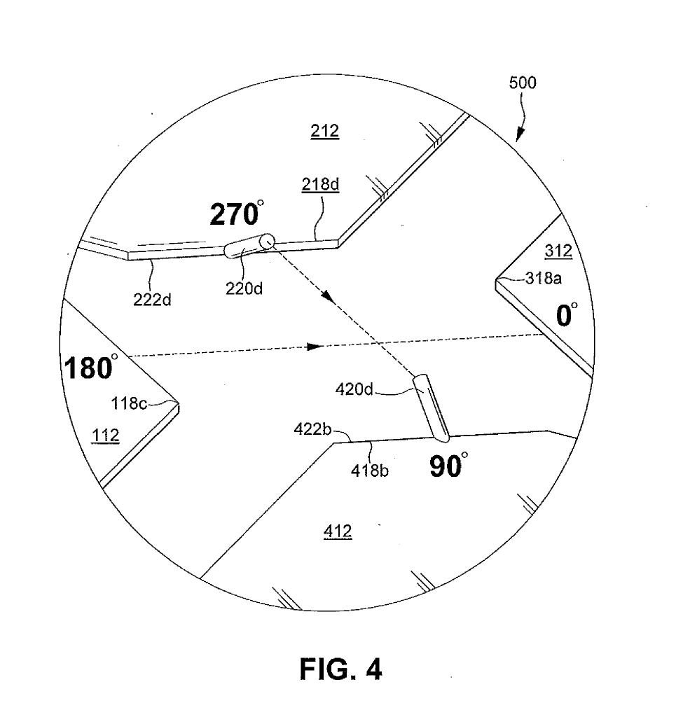

An enlarged view of the slot intersection 500 between the four adjacent patches 112, 212, 312, 412 of FIG. 3 is shown in FIG. 4. The slot intersection 500 is formed at the vertex of the square tiled patches 112, 212, 312, 412, and in particular by the third corner 118c of the first patch 112, the fourth corner 218d of the second patch 212, the first corner 318a of the third patch 312, and the second corner 418b of the fourth patch 412. To facilitate attachment of the feed systems (not shown), the various corners of the patches 112, 212, 312, 412 may be beveled. For example, as shown in FIG. 4, the fourth corner 218d of the second patch 212 is beveled to form an attachment edge 222d for receiving a progressive signal feed 220d. Similarly, the second corner 418b of the fourth patch 412 includes a beveled edge 422b for receiving a progressive signal feed 420d. The third corner 118c of the first patch 112 and the first corner 318a of the third patch 312 are shown without beveling. However, it is understood that any of the corners may be beveled to facilitate attachment of the progressive signal feeds to the corners.

Advantageously, because of the square filing geometric arrangement of the substantially square patches 112, 212, 312, 412, and because of the progressive signal feeds to each respective corner of the substantially square patches 112, 212, 312, 412, each corner that comprises the slot intersection 500 is progressively fed 90° out of phase with the preceding corner, commencing with the first corner 318a of the third patch. The four corners 318a, 418b, 118c, 218d are thus physically and electrically 90° out of phase with respect to each other. Because the four corners 318a, 418b, 118c, 218d are progressively fed in phase quadrature, the antenna at the slot intersection 500 approximates that of a crossed dipole element, wherein the corners 318a and 118c form a first dipole, and the corners 218d and 418b form a second dipole orthogonal to the first dipole, thereby further enhancing the bandwidth of the patch antenna array 100 while maintaining good circular polarization.

The quad-fed patch antenna 10 and the quad-fed patch antenna array 100 of the present invention provide extremely robust circular polarization having an axial ratio of less than about 2.0 dB across a very large bandwidth, greater than 150 MHz. Unlike single feed (such as demonstrated with reference to FIG. 2A) or dual feed patch antennas (such as demonstrated with reference to FIG. 2B or FIG. 2C), the quad-fed patch antenna of the present disclosure is not bandwidth limited due to the poor circular polarization, and therefore does not encounter a gain loss due to poor circular polarization.

While certain representative embodiments and details have been shown for purposes of illustrating the invention, it will be apparent to those skilled in the art that various changes may be made without departing from the scope of the disclosure, which is further described in the following appended claims.

What is claimed is:

1. A quad-fed patch antenna comprising:
a ground plane having an upper surface substantially within a first plane;
a substantially tetragonal radiating patch spaced from the ground plane, an upper surface of the substantially tetragonal radiating patch having a first edge, a second edge, a third edge, and a fourth edge, the edges defining a first corner, a second corner, a third corner, and a fourth corner therebetween located within a second plane substantially parallel to the first plane;
a first signal feed feeding the first edge of the substantially tetragonal radiating patch;
a second signal feed feeding the second edge of the substantially tetragonal radiating patch;
a third signal feed feeding the third edge of the substantially tetragonal radiating patch; and
a fourth signal feed feeding the fourth edge of the substantially tetragonal radiating patch, wherein the first signal feed, the second signal feed, the third signal feed and the fourth signal feed are fed progressively in phase quadrature.

2. The quad-fed patch antenna of claim 1, wherein the substantially tetragonal radiating patch is mounted on a dielectric.

3. The quad-fed patch antenna of claim 1, wherein the substantially tetragonal radiating patch is substantially square.

4. The quad-fed patch antenna of claim 1, wherein the first signal feed is attached to the first corner, the second signal feed is attached to the second corner, the third signal feed is attached at the third corner, and the fourth signal feed is attached at the fourth corner.

5. The quad-fed patch antenna of claim 4, wherein the second signal feed is offset clockwise in respect of the first signal feed, the third signal feed is offset clockwise in respect of the second signal feed, and the fourth signal feed is offset clockwise in respect of the third signal feed.

6. The quad-fed patch antenna of claim 4, wherein the second signal feed is offset counter-clockwise in respect of the first signal feed, the third signal feed is offset counter-clockwise in respect of the second signal feed, and the fourth signal feed is offset counter-clockwise in respect of the third signal feed.

7. A quad-fed patch antenna array, comprising:
a ground plane having a surface substantially within a first plane;
a plurality of substantially coplanar tetragonal radiating patches spaced from and substantially parallel to the first plane and electrically isolated from each other;
each substantially coplanar tetragonal radiating patch having a first side, a second side, a third side, and a fourth side, the sides defining a first corner, a second corner, a third corner, and a fourth corner therebetween;
a first signal feed feeding each of the first sides of the plurality of substantially coplanar tetragonal radiating patches;
a second signal feed feeding each of the second sides of the plurality of substantially coplanar tetragonal radiating patches;
a third signal feed feeding each of the third sides of the plurality of substantially coplanar tetragonal radiating patches; and
a fourth signal feed feeding each of the fourth sides of the plurality of substantially coplanar tetragonal radiating patches, wherein each of the first signal feeds are received substantially simultaneously by the plurality of substantially coplanar tetragonal radiating patches, each of the second signal feeds are received substantially simultaneously by the plurality of substantially coplanar tetragonal radiating patches, each of the third signal feeds are received substantially simultaneously by the plurality of substantially coplanar tetragonal radiating patches, and each of the fourth signal feeds are received substantially simultaneously by the plurality of substantially coplanar tetragonal radiating patches, and wherein the first signal feeds, the second signal feeds, the third signal feeds, and the fourth signal feeds are fed progressively in phase quadrature.

8. The quad-fed patch antenna array of claim 7, wherein each of the plurality of substantially coplanar tetragonal radiating patches is substantially square.

9. The quad-fed patch antenna array of claim 8, wherein the plurality of substantially coplanar tetragonal radiating patches is arranged in a square tiling configuration wherein four of the substantially coplanar tetragonal radiating patches are located proximate each vertex.

10. The quad-fed patch antenna array of claim 9, wherein the first corners of each of the substantially coplanar tetragonal radiating patches, the second corners of each of the substantially coplanar tetragonal radiating patches, the third corners of each of the substantially coplanar tetragonal radiating patches, and the fourth corners of each of the substantially coplanar tetragonal radiating patches have the same geometric orientation on each of the plurality of substantially coplanar tetragonal radiating patches.

11. The quad-fed patch antenna array of claim 10, wherein the first signal feeds are attached to each of the first corners of the plurality of substantially coplanar tetragonal radiating patches, the second signal feeds are attached to each of the second corners of the plurality of substantially coplanar tetragonal radiating patches, the third signal feeds are attached to each of the third corners of the plurality of substantially coplanar tetragonal radiating patch, and the fourth signal feeds are attached to each of the fourth corners of the plurality of substantially coplanar tetragonal radiating patches.

12. The quad-fed patch antenna array of claim 11, wherein the second signal feed of each of the substantially coplanar tetragonal radiating patches is offset clockwise in respect of the first signal feed of the substantially coplanar tetragonal radiating patch, each third signal feed of each of the substantially coplanar tetragonal radiating patches is located clockwise in respect of the second signal feed of the substantially coplanar tetragonal radiating patch, and each fourth signal feed of each of the substantially coplanar tetragonal radiating patches is located clockwise in respect of the third signal feed of the substantially coplanar tetragonal radiating patch.

13. The quad-fed patch antenna array of claim 11, wherein the second signal feed of each of the substantially coplanar tetragonal radiating patches is located counter-clockwise in respect of the first signal feed of the substantially coplanar tetragonal radiating patch, each third signal feed of each of the substantially coplanar tetragonal radiating patches is located counter-clockwise in respect of the second signal feed of the substantially coplanar tetragonal radiating patch, and each fourth signal feed of each of the substantially coplanar tetragonal radiating patches is located counter-clockwise in respect of the third signal feed of the substantially coplanar tetragonal radiating patch.

14. The quad-fed patch antenna array of claim 11, wherein each of the substantially coplanar tetragonal radiating patches is separated by a gap to form a slot at each vertex.

15. A quad-fed patch antenna array, comprising:
a ground plane having a surface substantially within a first plane;
a plurality of substantially square radiating patches spaced from and substantially parallel to the first plane and electrically isolated from each other, the plurality of substantially square radiating patches arranged in a square tiling configuration to provide four of the substantially square radiating patches proximate each vertex;
each substantially square radiating patch having a first corner, a second corner, a third corner, and a fourth corner;
a first signal feed attached to each of the first corners of the plurality of substantially square radiating patches;
a second signal feed attached to each of the second corners of the plurality of substantially square radiating patches;
a third signal feed attached to each of the third corners of the plurality of substantially square radiating patches; and
a fourth signal feed attached to each of the fourth corners of the plurality of substantially square radiating patches, wherein the first signal feeds are received substantially simultaneously by the plurality of substantially square radiating patches, the second signal feeds are received substantially simultaneously by the plurality of substantially square radiating patches, the third signal feeds are received substantially simultaneously by the plurality of substantially square radiating patches, and the fourth signal feeds are received substantially simultaneously by the plurality of substantially square radiating patches, and wherein the first signal feeds, the second signal feeds, the third signal feeds, and the fourth signal feeds are fed progressively in phase quadrature.

16. The quad-fed patch antenna array of claim 15, wherein each of the substantially square radiating patches is separated by a gap to form a slot at each vertex.

17. The quad-fed patch antenna of claim 17, wherein each of the four substantially square radiating patches around each vertex is progressively fed 90° out of phase.

18. The quad-fed patch antenna array of claim 15, wherein the first corners of each of the substantially square radiating patches, the second corners of each of the substantially square radiating patches, the third corners of each of the substantially square radiating patches, and the fourth corners of each of the substantially square radiating patches are have the same geometric orientation on each of the plurality of substantially square radiating patches.

19. The quad-fed patch antenna array of claim 11, wherein the second signal feed of each of the substantially square radiating patches is located clockwise in respect of the first signal feed of the substantially square radiating patch, each third signal feed of each of the substantially square radiating patches is located clockwise in respect of the second signal feed of the substantially square radiating patch, and each fourth signal feed of each of the substantially square radiating patches is located clockwise in respect of the third signal feed of the substantially square radiating patch.

20. The quad-fed patch antenna array of claim 11, wherein the second signal feed of each of the substantially square radiating patches is located counter-clockwise in respect of the first signal feed of the substantially square radiating patch, each third signal feed of each substantially square radiating patch is located counter-clockwise in respect of the second signal feed of the substantially square radiating patch, and each fourth signal feed of each substantially square radiating patch is located counter-clockwise in respect of the third signal feed of the substantially square radiating patch.
